(19) United States
(12) Patent Application Publication
(10) Pub. No.: US 2012/0113358 A1
(43) Pub. Date: May 10, 2012

(54) DISPLAY APPARATUS AND BACK LIGHT APPARATUS

(76) Inventors: Masako KASHIWAGI, Yokohama-Shi (JP); Shinichi Uehara, Tokyo (JP)

(21) Appl. No.: 13/049,958

(22) Filed: Mar. 17, 2011

(30) Foreign Application Priority Data
Nov. 10, 2010 (JP) 2010-252008

(51) Int. Cl. G02F 1/13357; G09F 13/04

(52) U.S. Cl. 349/65; 362/97.1; 349/62

(57) ABSTRACT

A back light apparatus according to an embodiment includes: an optical aperture part comprising a plurality of optical apertures arranged in parallel to each other; a light source unit comprising a plurality of line sources, the light source unit configured to generate line-shaped light rays associated with the optical apertures respectively; and a diffusion state switching unit configured to be capable of switching a diffusion state of light illuminated from the light source unit.

### CROSS REFERENCE TO RELATED APPLICATIONS

This application is based upon and claims the benefit of priority from prior Japanese Patent Application No. 2010-252008 filed on Nov. 10, 2010 in Japan, the entire contents of which are incorporated herein by reference.

### FIELD

Embodiments described herein relate generally to a display apparatus and a back light apparatus.

### BACKGROUND

Various schemes are known as a stereoscopic image display scheme which does not require dedicated glasses or the like. In display panels such as liquid crystal display apparatuses of direct view type or projection type or plasma display apparatuses, pixel positions are fixed. In such display panels, a scheme of installing an optical plate, which controls a light ray emitted from a display panel and which directs the light ray to a viewer, immediately before the display panel is known as a scheme which can be implemented with comparative ease.

Typically, the optical plate is also called parallax barrier. The optical plate controls the light ray to make different images seen depending upon the angle even if the position on the optical plate is the same. Specifically, when only lateral parallax (horizontal disparity) is given, a slit or a lenticular sheet (cylindrical lens array) is used as the optical plate. When vertical parallax (vertical disparity) is also included, a pinhole array or a lens array is used as the optical plate. Schemes using the parallax barrier are also further classified into binocular, multiview, super-multiview (super-multiview condition of super-multiview), and integral photography (IP). A basic principle of them is substantially the same as that used in a stereoscopic photograph invented approximately 100 years ago.

In recent years, switching display between a two-dimensional image and a three-dimensional image has become an indispensable function in uses of personal computers and uses of television. As the technique for implementing the switching between the two-dimensional image and the three-dimensional image, a method of conducting the display of a two-dimensional image and a three-dimensional image by installing a plurality of line sources on the back of a lens and conducting switching between individual lighting of the line sources and lighting of all the line sources, a method of conducting the display of a two-dimensional image and a three-dimensional image by installing a barrier and a high dispersion type liquid crystal on a flat light source and turning on/off the diffusion state electrically, and a method of installing a diffusion state switching unit in front of a flat light source patterned in a matrix or stripe form and a lenticular sheet and turning on/off the diffusion state are disclosed. In the conventional techniques, however, it is difficult to reconcile the picture quality and the light utilization efficiency.

### BRIEF DESCRIPTION OF THE DRAWINGS

FIG. 1 is a diagram showing a display apparatus according to a first embodiment;

FIG. 2 is a diagram showing a display apparatus according to a first modification of the first embodiment;

FIGS. 3(a) to 3(c) are diagrams for explaining a diffusion state of the display apparatus according to the first embodiment;

FIG. 4 is a diagram showing a control unit in the display apparatus according to the first embodiment;

FIGS. 5(a) and 5(b) are diagrams showing display apparatuses according to a second modification and a third modification of the first embodiment;

FIG. 6 is a diagram showing a control unit which conducts time division drive of the display apparatus according to the first embodiment;

FIGS. 7(a) and 7(b) are diagrams for explaining operation of a display apparatus according to a fourth modification of the first embodiment;

FIGS. 8(a) and 8(b) are diagrams for explaining operation of the display apparatus according to the fourth modification of the first embodiment;

FIGS. 9(a) and 9(b) are diagrams for explaining operation of a display apparatus according to a fifth modification of the first embodiment;

FIGS. 10(a) and 10(b) are diagrams for explaining operation of the display apparatus according to the fifth modification of the first embodiment;

FIG. 11 is a diagram showing relations between a light source width of line sources and an aperture width of an optical aperture part;

FIG. 12 is a diagram showing dependence of parallax crosstalk upon the light ray width of line sources;

FIGS. 13(a) and 13(b) are diagrams showing luminance profiles in a three-dimensional image display mode and a two-dimensional image display mode;

FIGS. 14(a) to 14(d) are diagrams showing modifications of the display apparatus according to the first embodiment;

FIG. 15 is a diagram for explaining diffusion states in the modifications shown in FIGS. 14(a) to 14(d);

FIG. 16 is a diagram showing a light source unit according to a second embodiment;

FIG. 17 is a diagram showing a light source unit according to a first modification of the second embodiment;

FIG. 18 is a diagram showing a light source unit according to a second modification of the second embodiment;

FIG. 19 is a diagram showing a light source unit according to a third modification of the second embodiment; and

FIG. 20 is a diagram showing a light source unit according to a fourth modification of the second embodiment.

### DETAILED DESCRIPTION

Hereafter, embodiments of a display apparatus and a back light apparatus according to the present invention will be described more specifically with reference to the drawings.

A back light apparatus according to an embodiment includes: an optical aperture part comprising a plurality of optical apertures arranged in parallel to each other; a light source unit comprising a plurality of line sources, the light source unit configured to generate line-shaped light rays associated with the optical apertures respectively; and a diffusion state switching unit configured to be capable of switching a diffusion state of light illuminated from the light source unit.

### First Embodiment

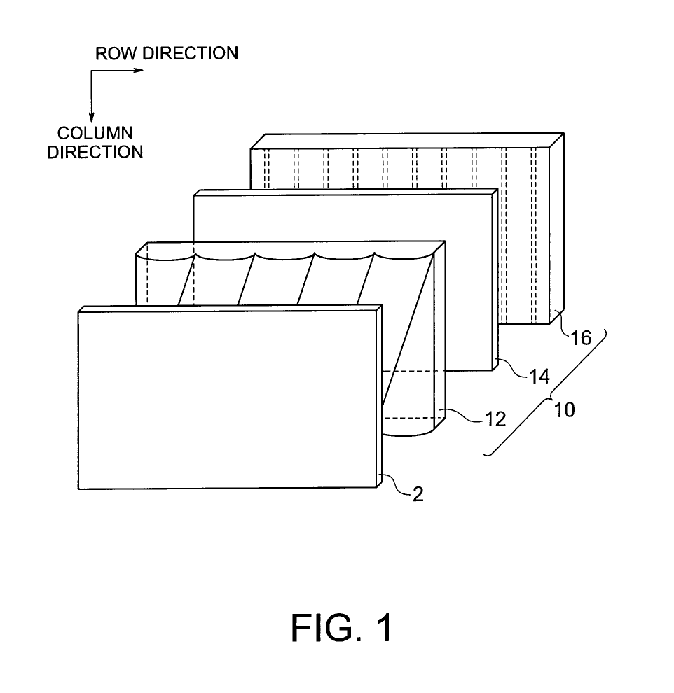

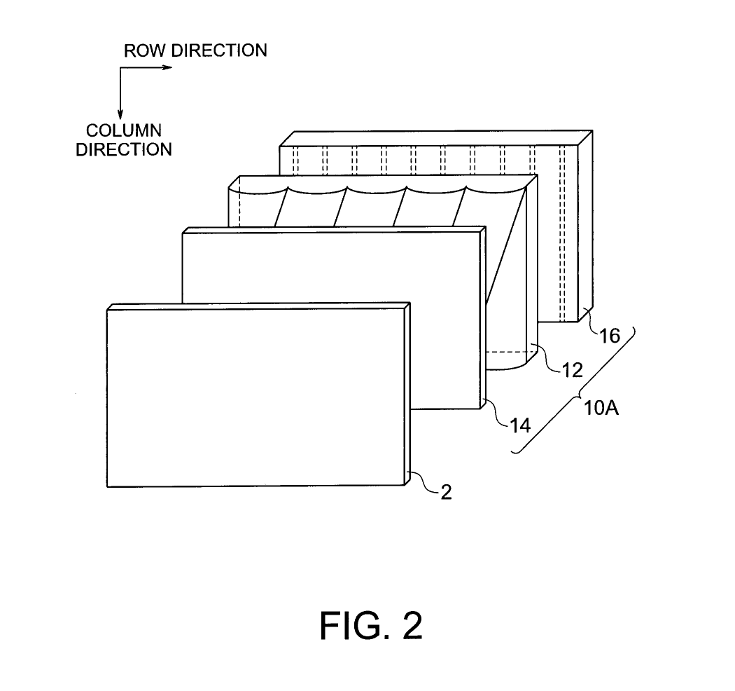

A display apparatus according to a first embodiment is shown in FIG. 1. The display apparatus according to this embodiment includes a display panel 2 and a back light apparatus 10. The back light apparatus 10 is a back light apparatus capable of generating directional light. The back light apparatus 10 includes an optical aperture part (light ray control unit) 12 comprising a plurality of optical apertures arranged in parallel in a column direction of the display panel 2, a diffusion state switching unit 14 capable of electrically switching among a plurality of diffusion states, and a light source unit 16 having at least one line source provided to be associated with respective optical apertures and generate linear light. By the way, in the present embodiment, the back light apparatus 10 is provided on a back side of the display panel 2, i.e., on a side of a face opposite to a face opposed to a viewer who is not illustrated. And the optical aperture part 12 is provided between the display panel 2 and the light source unit 16, and the diffusion state switching unit 14 is provided between the light source unit 16 and the optical aperture part 12. By the way, a configuration according to a first embodiment shown in FIG. 2 may also be used. The first modification has a configuration obtained by replacing the back light apparatus 10 according to the first embodiment with a back light apparatus 10A. The back light apparatus 10A in the first modification differs from the back light apparatus 10 in disposition of the diffusion state switching unit 14, and the back light apparatus 10A has a configuration in which the diffusion state switching unit 14 is provided between the display panel 2 and the optical aperture part 12. By the way, in display apparatuses according to respective modifications described later as well, the configuration in which the diffusion state switching unit 14 is provided between the display panel 2 and the optical aperture part 12 may be used in the same way as the first modification.

In the present embodiment, the optical aperture part 12 is a parallax barrier which gives horizontal parallax, and a lenticular sheet (cylindrical lens array) or a slit sheet having a plurality of slits is used. In other words, if the optical aperture part is a cylindrical lens array, each cylindrical lens is an optical aperture. If the optical aperture part is a slit sheet, each slit becomes an optical aperture. In FIG. 1, a cylindrical lens array is shown as the optical aperture part 12.

The diffusion state switching unit 14 is switched to a plurality of diffusion states by a diffusion control unit which will be described later, one diffusion state or a plurality of diffusion states are generated in a region associated with one pitch of the optical aperture part 12. In the diffusion state switching unit 14, for example, a structure having macromolecules formed in a network form in macromolecule dispersion type liquid crystal or liquid crystal is provided between two control electrodes. In a state in which a voltage is applied between the two control electrodes, orientation of the liquid crystal is aligned and the liquid crystal becomes transparent. In a state in which a voltage is not applied, liquid crystal lines irregularly, resulting in a diffusion state and cloudiness. In this diffusion state, the ratio of cloudiness can be changed electrically. Here, the diffusion state of the diffusion state switching unit 14 is represented by a haze value (=(transmittance in the diffusion state)/(whole light transmittance)×100). The greater the haze value is, the greater the diffusion and cloudiness becomes.

The light source unit 16 has a structure including an LED and a light guide plate for taking out light rectilinearly, or a spontaneous light element such as a plasma generation element or organic EL. By the way, if the diffusion state switching unit 14 is disposed on the back of the optical aperture part 12, i.e., if the diffusion state switching unit 14 is disposed between the optical aperture part 12 and the light source unit 16, it becomes possible to change the diffusion state and thereby change the width of the light ray arriving at the optical aperture part 12 even if the width of the line sources themselves of the light source unit 16 is not changed at the time of manufacturing.

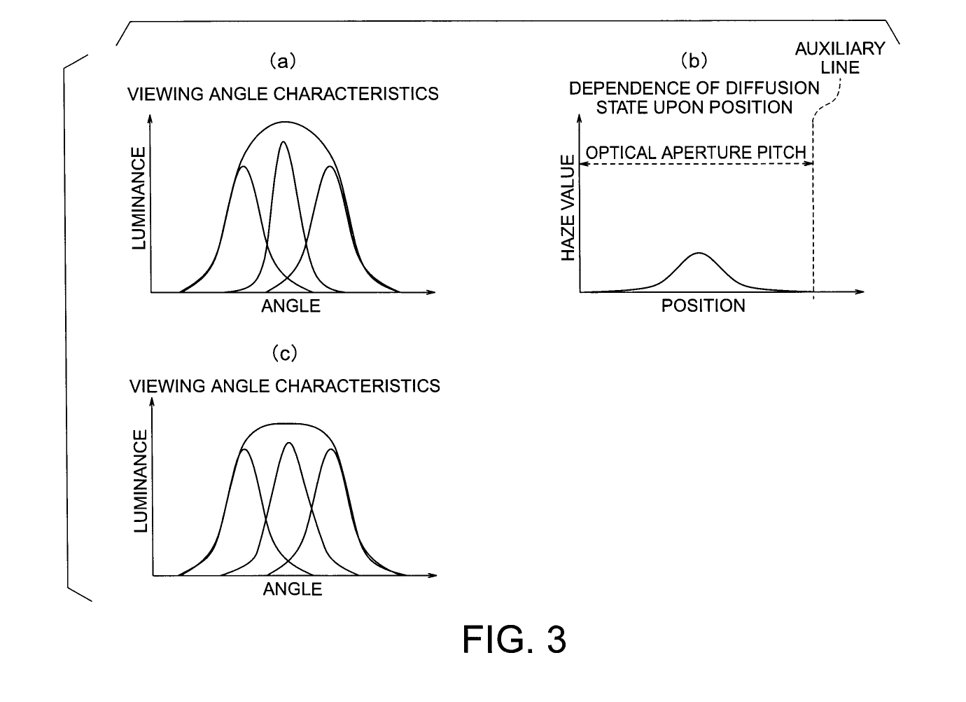

FIGS. 3(a), 3(b) and 3(c) show examples of a luminance profile generated by the light source unit 16 installed on the back of the optical aperture part 12. Typically, in the vicinity of the center of the optical aperture part 12, a profile having a sharp peak is obtained and the luminance is high. As the position advances to the peripheral part, the luminance falls and a luminance difference is generated. In this case, as shown in FIG. 3(a), a narrow peak width exists near the center, and the viewing angle characteristics felt by the eyes is aggravated. On the other hand, if the diffusion state in the vicinity of the center of the optical aperture part 12 is increased by the diffusion state switching unit 14 as shown in FIG. 3(b), viewing angle characteristics having a wide peak width can be approached as shown in FIG. 3(c). For providing the diffusion state with distribution in a region associated with each pitch of the optical aperture part 12, a plurality of transparent electrodes should be installed in a region associated with each pitch of the optical aperture part 12.

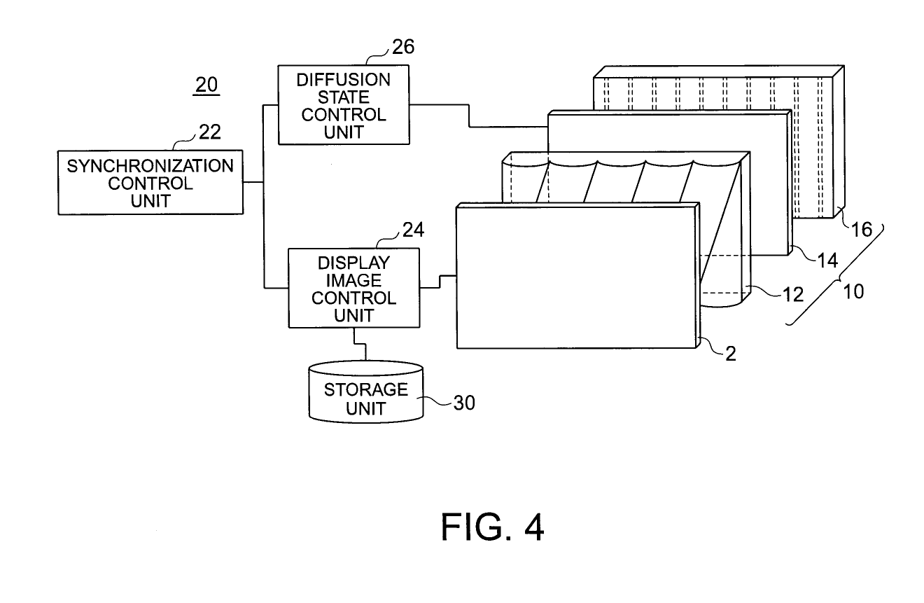

As shown in FIG. 4, a control unit 20 and a storage unit 30 are provided in the display apparatus according to the present embodiment. The control unit 20 includes a synchronization control unit 22, a display image control unit 24, and a diffusion control unit 26. The synchronization control unit 22 exercises control to synchronize control operation in the display image control unit 24 with control operation in the diffusion control unit 26. The storage unit 30 stores image data sent from the external. The display image control unit 24 sends the image data stored in the storage unit 30 to the display panel 2 and controls a display image, according to an image display mode. For example, if the image data stored in the storage unit 30 is two-dimensional image data, the display image control unit 24 sends the image data as it is to the display panel 2 and causes the image data to be displayed. If the image data stored in the storage unit 30 is three-dimensional image data, the image is converted to multiple parallax images (for example, nine parallax images), an image for three-dimensional image display is generated by rearranging pixels which are components of each of the multiple parallax images every aperture of the optical aperture part 12, and the image for three-dimensional image display is sent to the display panel 2. By the way, if each parallax image is formed of three sub-pixels (for example, R (red), G (green) and B (blue), processing of rearranging information of a pixel unit by taking a sub-pixel as the unit is conducted and then an image for three-dimensional image display is generated. As shown in JP-A-2006-98779 (KOKAI), conversion to a format (for example, tile images) suitable for transmission or compression of parallax images may be conducted by putting together only actually required parts of parallax images. The diffusion control unit 26 exercises control to electrically switch the diffusion state of the diffusion state switching unit 14 by using the image display mode (a two-dimensional image display mode or a three-dimensional image display mode) and a lighting mode of the line sources which will be described later.

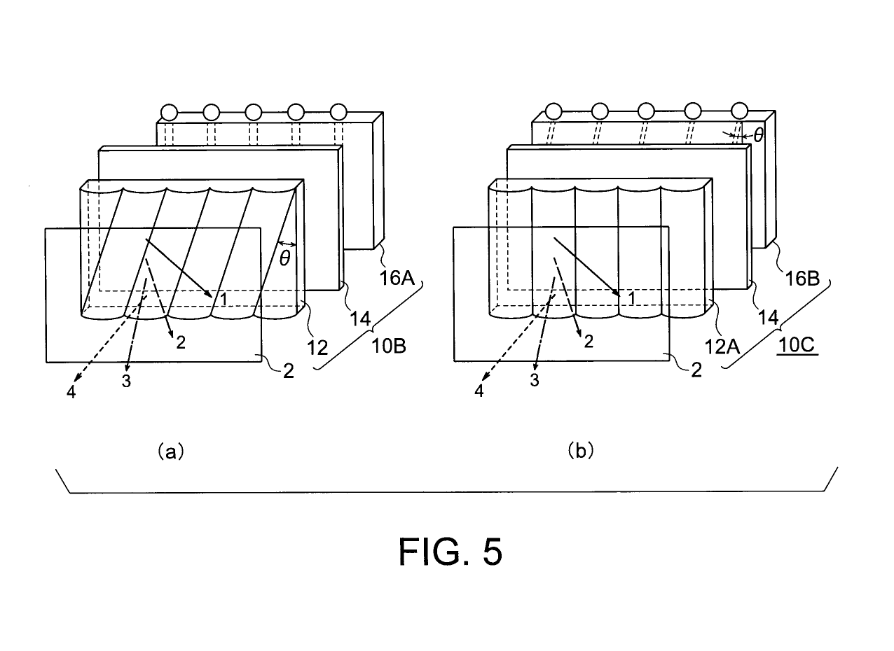

The back light apparatus may be constituted as in a second modification and a third modification respectively shown in FIGS. 5(a) and 5(b). A back light apparatus 10B in the second modification shown in FIG. 5(a) includes an optical aperture part 12, a diffusion state switching unit 14, and a light source unit 16A. The optical aperture part 12 has the same configuration as that of the optical aperture part 12 in the first embodiment shown in FIG. 1. In the configuration, ridgelines of apertures, for example, lenticular lenses are inclined with respect to the column direction. The diffusion state switching unit 14 has the same configuration as that of the diffusion state switching unit 14 in the first embodiment shown in FIG. 1. The light source unit 16A has a configuration in which one line source is provided for each aperture in the optical aperture part 12 as for the number of line sources, and the light sources extend in the column direction. In other words, a light source in the light source unit 16A and a ridgeline of a lenticular lens in the optical aperture part 12 form a certain inclination angle θ. It is desirable that this inclination angle θ satisfies the following equation.

θ=tan⁻¹ (p_{L}/(n×p_{sub}))

Here, n is a positive integer of at least 2, p_{L} is a lens pitch, and p_{sub} is a width of each sub-pixel in the display panel 2.

The back light apparatus 10C in the third modification shown in FIG. 5(b) includes an optical aperture part 12A, a diffusion state switching unit 14, and a line source 16B. Unlike the optical aperture part 12 in the first embodiment shown in FIG. 1, the optical aperture part 12A has a configuration in which ridgelines of apertures such as lenticular lenses are disposed along the column direction. The diffusion state switching unit 14 has the same configuration as that of the diffusion state switching unit 14 in the first embodiment shown in FIG. 1. The light source unit 16B has a configuration in which one light source is provided for each aperture in the optical aperture part 12A, and the light sources are inclined with respect to the column direction. In other words, a light source in the light source unit 16B and a ridgeline of a lenticular lens in the optical aperture part 12A form a certain inclination angle θ. It is desirable that this inclination angle θ satisfies the following equation.

θ=tan⁻¹(p_{L}/(n×p_{sub}))

Here, n is a positive integer of at least 2, p_{L} is a lens pitch, and p_{sub} is a width of each sub-pixel in the display panel 2.

In both the second and third modifications, the light source units has a configuration in which one light source is provided for each aperture in the optical aperture part as for the number of light sources. For generating parallax only in the back light apparatus, light rays having a directionality which differs from line to line in the row direction in the image display unit can be reproduced by making the ridgeline direction in the optical aperture part different from the ridgeline direction in line sources. The display apparatuses in the second and third modifications shown in FIGS. 5(a) and 5(b) show examples in which light rays in four directions, i.e., four parallaxes are generated with a period of four lines in the column direction.

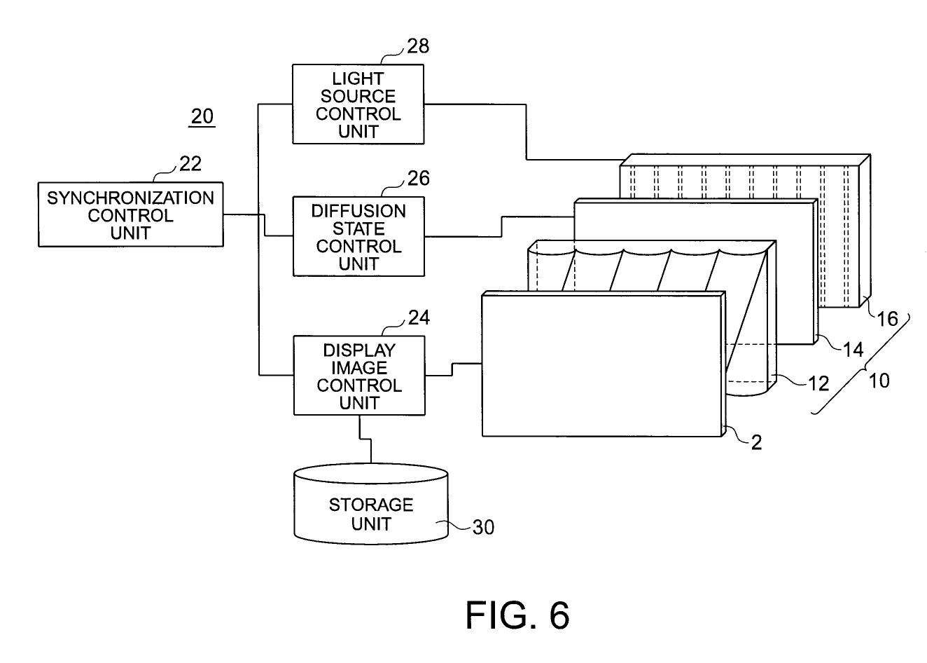

As shown in FIG. 6, the control unit 20 in the display apparatus according to the first embodiment further includes a light source control unit 28 which controls the light source unit 16. In the first embodiment, the light source unit 16 has as many line sources as the number N of time divisions for each aperture in the optical aperture part 12 in the back light apparatus 10. And the light source control unit 28 regards line sources associated with each aperture in the optical aperture part 12 as one set and controls turning on and off timing of line sources in each set. Furthermore, the display image control unit 24 controls switching timing of an element image (i.e., a set of images for each aperture in the optical aperture part 12) of the display panel 2. The synchronization control unit 22 conducts time division to synchronize control of the turning on and off timing of line sources in each set exercised by the light source control unit 28 with the switching timing of the elemental image conducted by the display image control unit 24. By the way, at this time, the diffusion state control unit 26 is also controlled to synchronize by the synchronization control unit 22.

If the drive frequency of the display panel 2 is 60 Hz×N in the time division drive, then flicker is not recognized visually in general. In the display of a stereoscopic image using the time division drive, the resolution of the three-dimensional image can be increased to N times. By the way, when displaying a two-dimensional image, all line sources should be lit.

### Fourth Modification

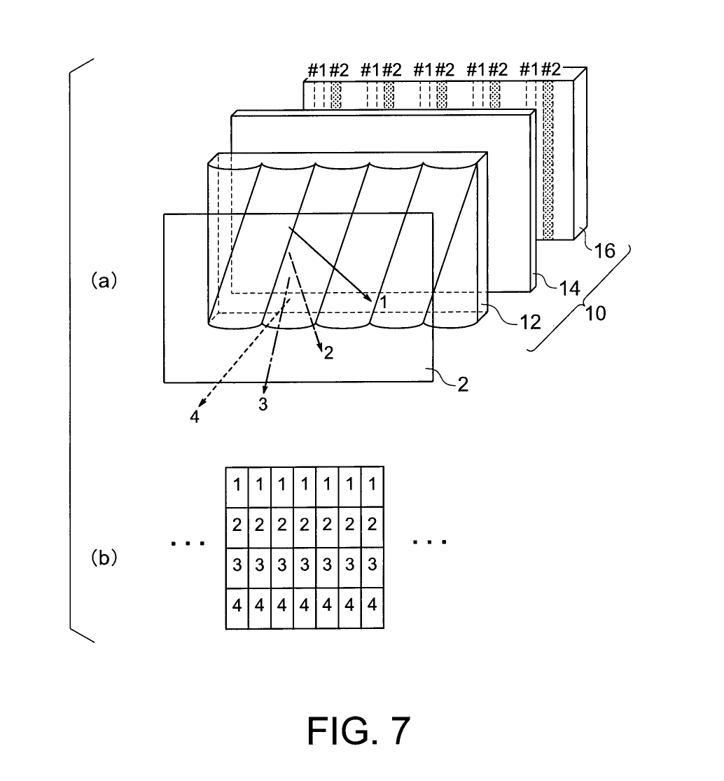

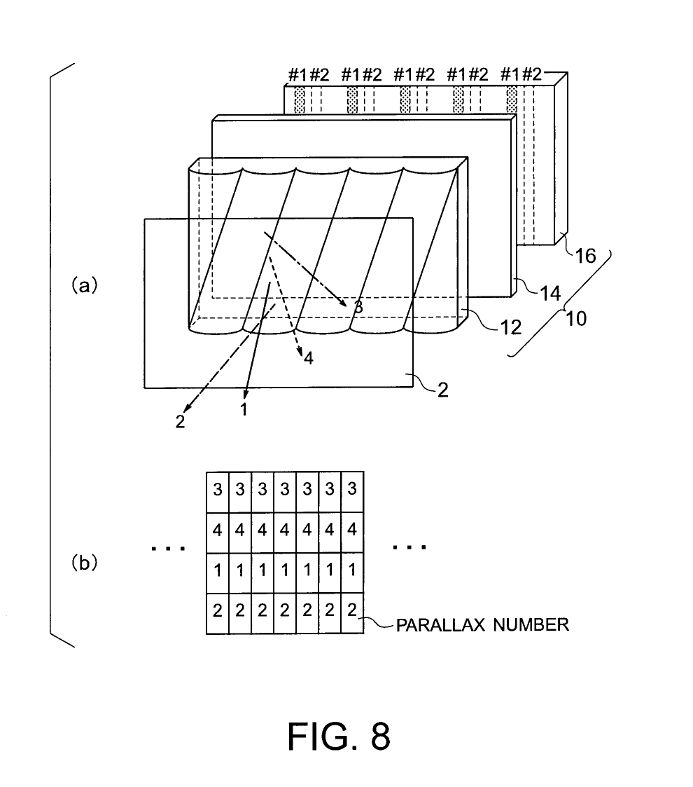

A configuration and operation of a display apparatus according to a fourth modification of the first embodiment will now be described with reference to FIGS. 7(a) to 8(b). The display apparatus according to the fourth modification is a display apparatus with the number N of time divisions being 2 and the number n of parallaxes being 4. The light source unit 16 has two line sources for each aperture in the optical aperture part 12. In FIGS. 7(a) and 8(a), one of the two line sources is denoted by #1 and used to represent a first field. In FIGS. 7(a) and 8(a), the other of the two line sources is denoted by #2 and used to represent a second field. By the way, in the fourth modification, the line sources #1 and #2 in the light source unit 16 extend along the column direction and apertures in the optical aperture part 12 are disposed to be inclined with respect to the column direction. FIGS. 7(a) and 7(b) show the display apparatus and elemental images of the first field in the case where the line sources #1 are lit. FIGS. 8(a) and 8(b) show the display apparatus and elemental images of the second field in the case where the line sources #2 are lit.

If the line sources #1 for the first field are lit in the fourth modification, a configuration of elemental images similar to that in the case described with reference to FIG. 5 is obtained (FIG. 7(b)). In other words, elemental images having a parallax number 1 are arranged in a certain line (for example, a first line), elemental images having a parallax number 2 are arranged in the next line (for example, a second line), elemental images having a parallax number 3 are arranged in, for example, a third line, and elemental images having a parallax number 4 are arranged in, for example, a fourth line (FIG. 7(b)). On the other hand, in the second field, the longitudinal resolution can be increased to N (=2) times, and consequently light rays in the same direction are reproduced every n/N lines and elemental images of the same parallax are interpolated in the longitudinal direction (FIG. 8(b)). In other words, elemental images having a parallax number 3 are arranged in a certain line (for example, the first line), elemental images having a parallax number 4 are arranged in the next line (for example, the second line), elemental images having a parallax number 1 are arranged in, for example, the third line, and elemental images having a parallax number 2 are arranged in, for example, the fourth line (FIG. 8(b)).

### Fifth Modification

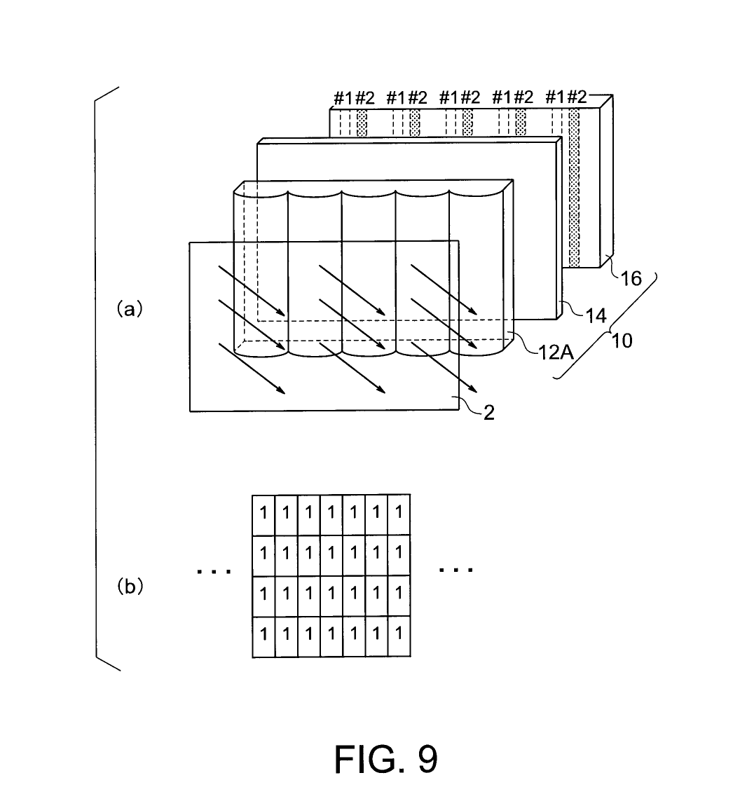

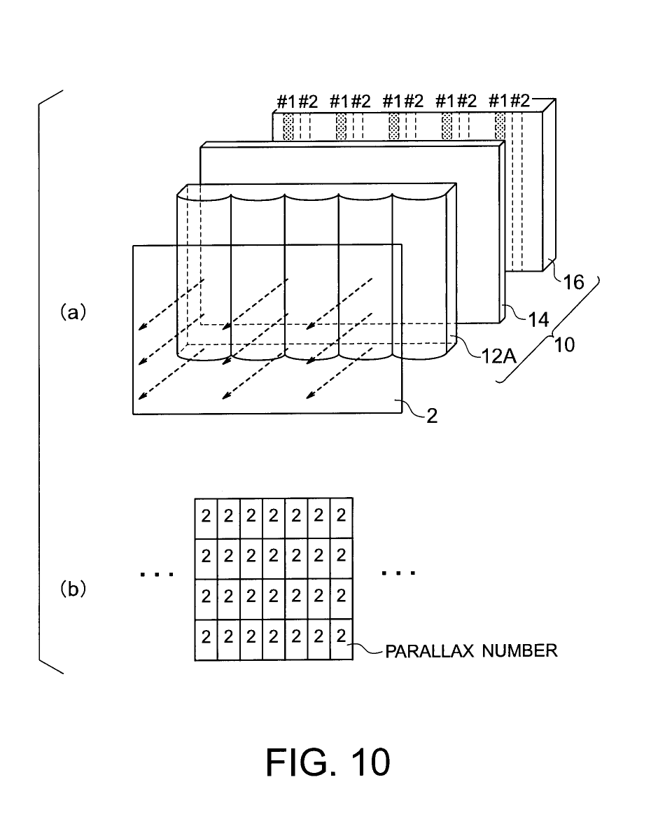

A configuration and operation of a display apparatus according to a fifth modification of the first embodiment will now be described with reference to FIGS. 9(a) to 10(b). The display apparatus according to the fifth modification is a display apparatus with the number N of time divisions being 2 and the number n of parallaxes being 2. The light source unit 16 has two line sources for each aperture in the optical aperture part 12. In FIGS. 9(a) and 10(a), one of the two line sources is denoted by #1 and used to represent a first field. In FIGS. 9(a) and 10(a), the other of the two line sources is denoted by #2 and used to represent a second field. By the way, in the fifth modification, the line sources #1 and #2 in the light source unit 16 extend along the column direction and apertures in the optical aperture part 12A are disposed to extend with respect to the column direction. FIGS. 9(a) and 9(b) show the display apparatus and elemental images of the first field in the case where the line sources #1 are lit. FIGS. 10(a) and 10(b) show the display apparatus and elemental images of the second field in the case where the line sources #2 are lit.

In the fifth modification, the ridgeline direction of the apertures in the optical aperture part 12A is parallel to the ridgeline direction of the line sources in the light source unit 16 and consequently it follows that the number N of time divisions=the number n of parallaxes. In other words, in the fifth modification, the number n of parallaxes is 2. In the first field, elemental images having a parallax number 1 are displayed as shown in FIG. 9(b). In the second field, elemental images having a parallax number 2 are displayed as shown in FIG. 10(b). In the fifth modification, therefore, the light ray direction is switched on the whole screen of the display panel 2 and the display resolution of the three-dimensional image becomes similar to the resolution of the display panel.

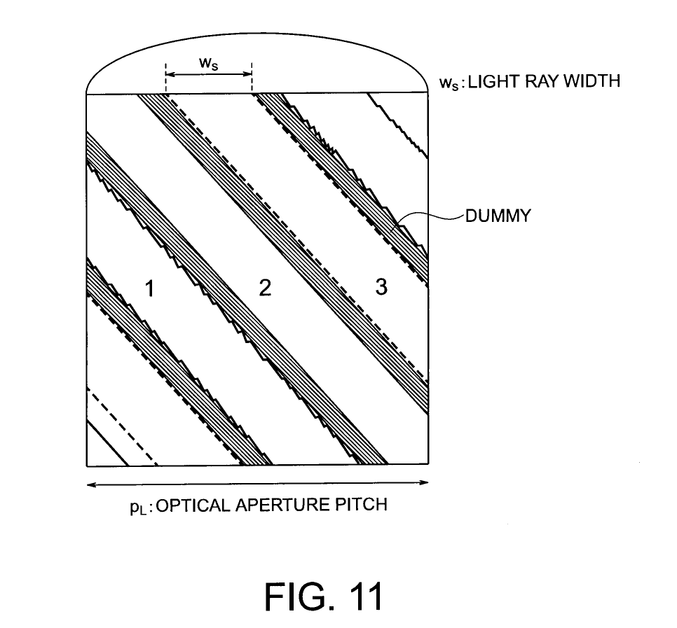

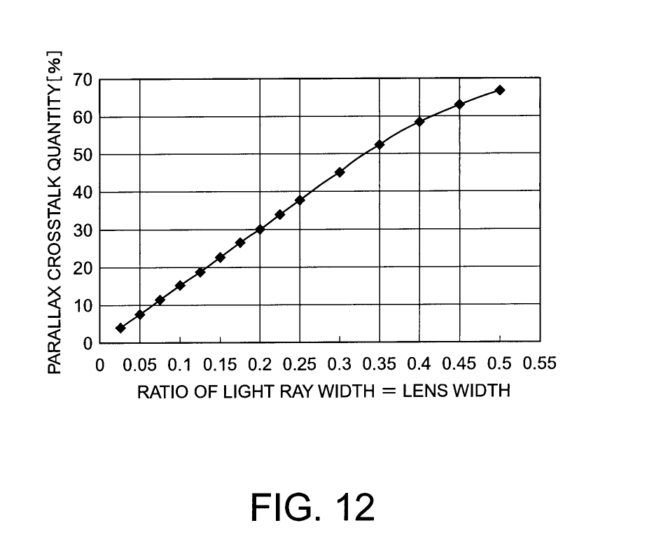

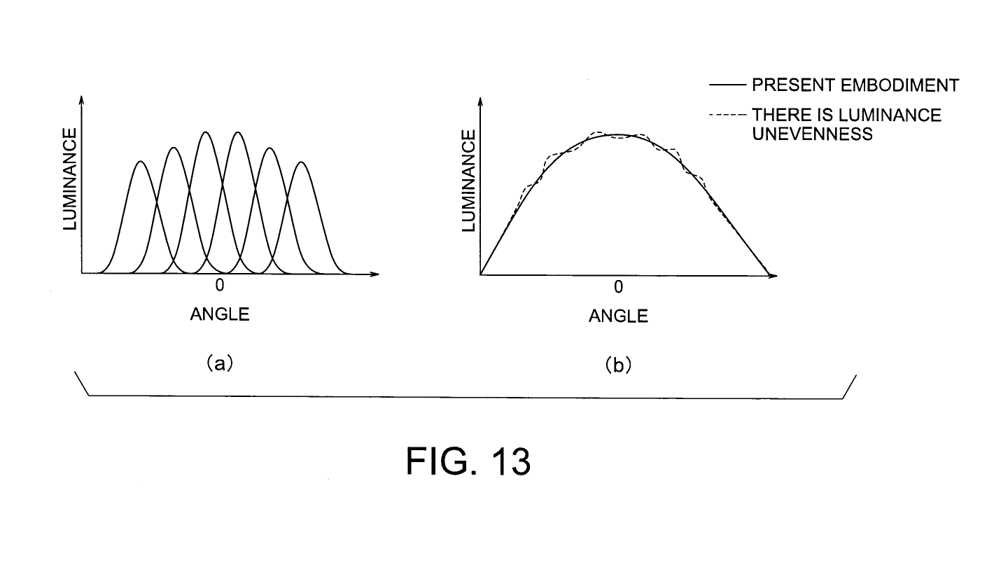

Relations between the parallax crosstalk quantity and the light ray width of the line sources and dependence of the luminance profile upon the angle will now be described with reference to FIGS. 11 to 13(b). FIG. 11 is a diagram showing relations between the light ray width of line sources and the width of apertures (for example, lenses) of the optical aperture part when the number of time divisions is three. FIG. 12 is a diagram showing dependence of parallax crosstalk upon the light ray width of the line sources when the light ray width of the line sources is the same as the width of the apertures. FIG. 13(a) is a graph showing dependence of the luminance profile upon the angle in the three-dimensional image display mode, and FIG. 13(a) is a graph showing dependence of the luminance profile upon the angle in the two-dimensional image display mode.

In FIG. 11, P_{L} denotes the pitch of the optical aperture part and W_{S} denotes the width of the line sources. As an example, the case where the ridgeline direction of the optical apertures is not parallel to the ridgeline direction of the line sources, the number of time divisions N=3 and the number of parallaxes n=6. In this case, three line sources are disposed in the pitch of the optical aperture part, and light turning on/off is switched sequentially at the time of three-dimensional image display whereas all line sources are lit at the time of two-dimensional image display.

As shown in FIG. 12, the parallax crosstalk depends upon the light ray width of the line sources. As the light ray width of the line sources is decreased, the parallax crosstalk quantity also decreases. It is desirable that the parallax crosstalk is less, because the parallax crosstalk causes a double image in the three-dimensional image. If the light ray width of the line sources is reduced, however, luminance unevenness becomes apt to occur in the two-dimensional image display mode (FIG. 13(b)). In the present embodiment and its modifications, the luminance unevenness is dissolved by control of the diffusion state of the dispersion type liquid crystal exercised by the diffusion state switching unit 14 (FIG. 13(b)).

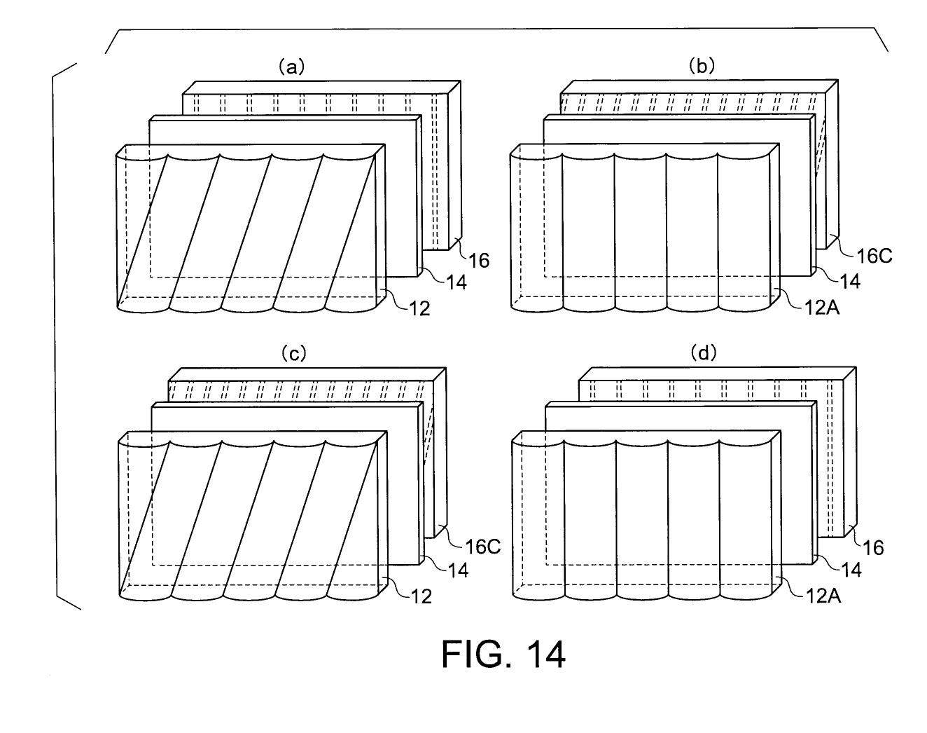

Display apparatuses according to the present embodiment and its modifications are sorted into patterns of four kinds as shown in FIGS. 14(a), 14(b), 14(c) and 14(d). The sorting into patterns of four kinds is conducted according to whether the ridgeline direction of the apertures in the optical aperture part and the ridgeline direction of the line sources in the light source unit are parallel or inclined to each other.

In FIG. 14(a), the apertures in the optical aperture part 12 are inclined obliquely with respect to the column direction of the display panel, and the ridgeline direction of the line sources in the light source unit 16 extends in the column direction. In FIG. 14(b), the apertures in the optical aperture part extends in the column direction, and the ridgeline direction of the line sources in the light source unit is inclined obliquely with respect to the column direction. In FIG. 14(c), the ridgeline direction of the apertures in the optical aperture part and the ridgeline direction of the line sources in the light source unit are parallel to each other, and their directions are inclined with respect to the column direction. In FIG. 14(d), the ridgeline direction of the apertures in the optical aperture part and the ridgeline direction of the line sources in the light source unit are parallel to each other, and they extend in the column direction.

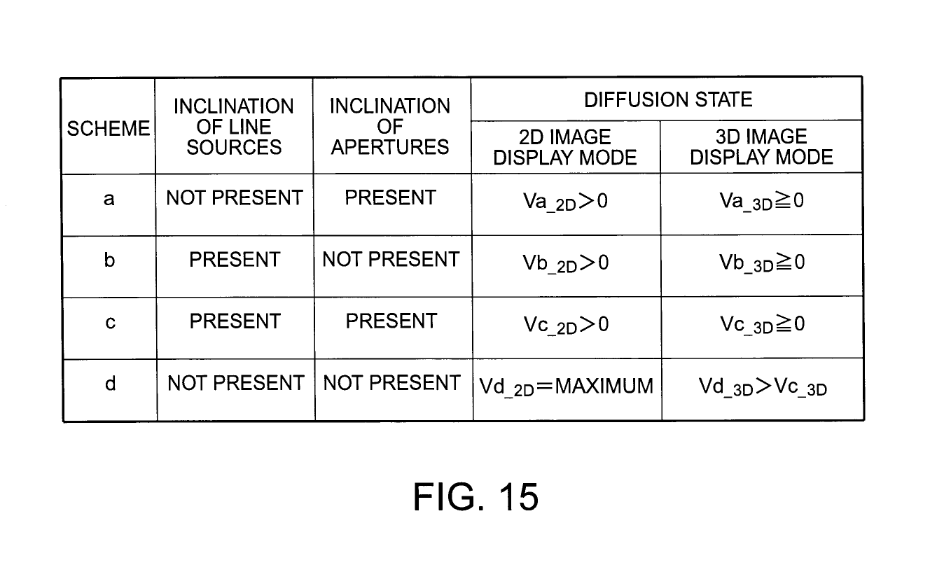

According to these four schemes, the diffusion states in the two-dimensional image display mode and the three-dimensional image display mode differ, and their combinations are shown in FIG. 15. In FIG. 15, schemes “a” to “d” correspond to FIGS. 14(a) to 14(d), Va to Vd are haze values indicating the diffusion states of respective schemes, and suffixes 2D and 3D indicate the two-dimensional image display mode and the three-dimensional image display mode, respectively. Combinations of diffusion states in the schemes “a” to “c” are nearly the same, and the value of the diffusion state substantially becomes a value that unevenness cannot be perceived visually in the state of the two-dimensional image display mode. On the other hand, diffusion states Va_{-3D}, Vb_{-3D} and Vc_{-3D} in the three-dimensional image display mode in the schemes “a” to “c” also become a diffusion state 0, i.e., a value that the unevenness cannot be perceived visually. In the case of the three-dimensional image display mode, the diffusion state may remain 0 if a contrivance is made in the shape of light sources to prevent luminance unevenness from being perceived visually. The scheme “c” has a structure that the luminance unevenness is the most perceivable visually in both the two-dimensional image display mode and the three-dimensional image display mode, and both modes require the diffusion state. In the scheme “d”, a maximum diffusion state is attained at the time of the two-dimensional image display mode, whereas at the time of the three-dimensional image display mode the value of the diffusion state substantially becomes a value that the luminance unevenness cannot be perceived visually. However, the value Vd_{-3D} is greater than the diffusion states Va_{-3D}, Vb_{-3D} and Vc_{-3D} in the schemes “a” to “c”. The visual perception of the luminance unevenness is a factor which differs among individuals, and for example, the diffusion state control unit 26 shown in FIG. 4 may be provided with a function of changing the diffusion state freely according to the user.

According to the first embodiment and its modifications, the picture quality degradation and the light utilization efficiency falling can be suppressed even if the switching between a two-dimensional image and a three-dimensional image is conducted.

### Second Embodiment

The back light apparatus used in the display apparatus according to the first embodiment will now be described in more detail.

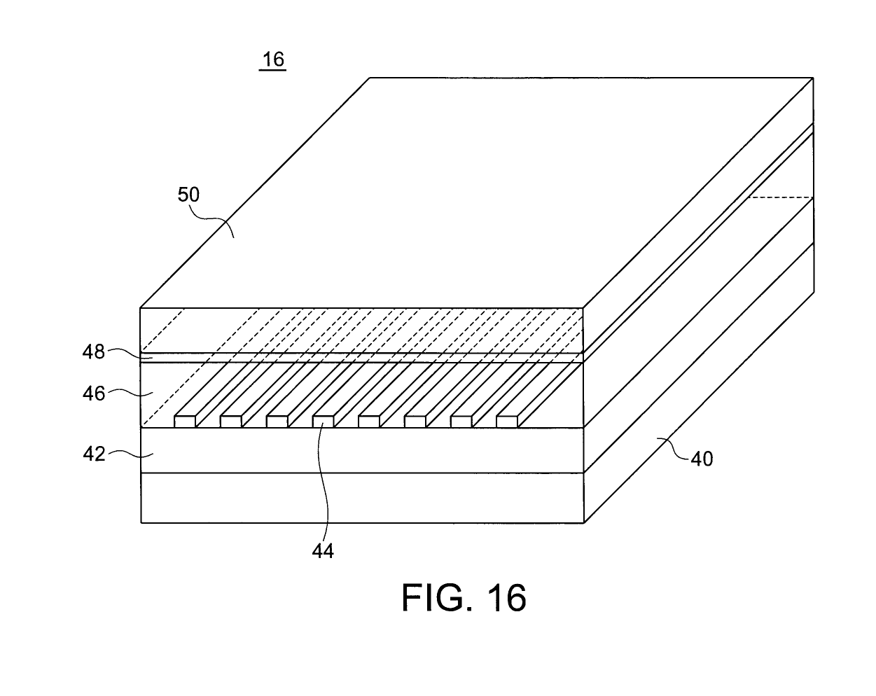

The light source unit 16 in the back light apparatus according to a second embodiment is shown in FIG. 16. The light source unit 16 according to the second embodiment includes a flat light source 40, a transparent substrate 42 provided on the flat light source 40, a plurality of transparent electrodes 44 which is provided on the transparent substrate 42, patterned in a line form so as to have a predetermined width, and formed of, for example, ITO (Indium Tin Oxide), a transparent opposed electrode 48 which is provided over the transparent substrate 42 and the transparent electrode 44 and which is formed of, for example, ITO, a dispersion type liquid crystal layer 46 sandwiched between the transparent substrate 42 and the transparent electrode 44, and the opposed electrode 48, and a transparent substrate 50 provided on the opposed electrode 48. If a voltage is applied between the transparent electrode 44 and the opposed electrode 48, the diffusion state is removed only in the dispersion type liquid crystal layer 46 over the transparent electrode 44, resulting in a transparent state. As for light generated from the flat light source 40, therefore, light transmitted by the transparent substrate 42, the transparent electrodes 44 supplied with the voltage, the liquid crystal layer 46 in the transparent state, the opposed electrode 48, and the transparent substrate 50 functions as the line source.

### First Modification

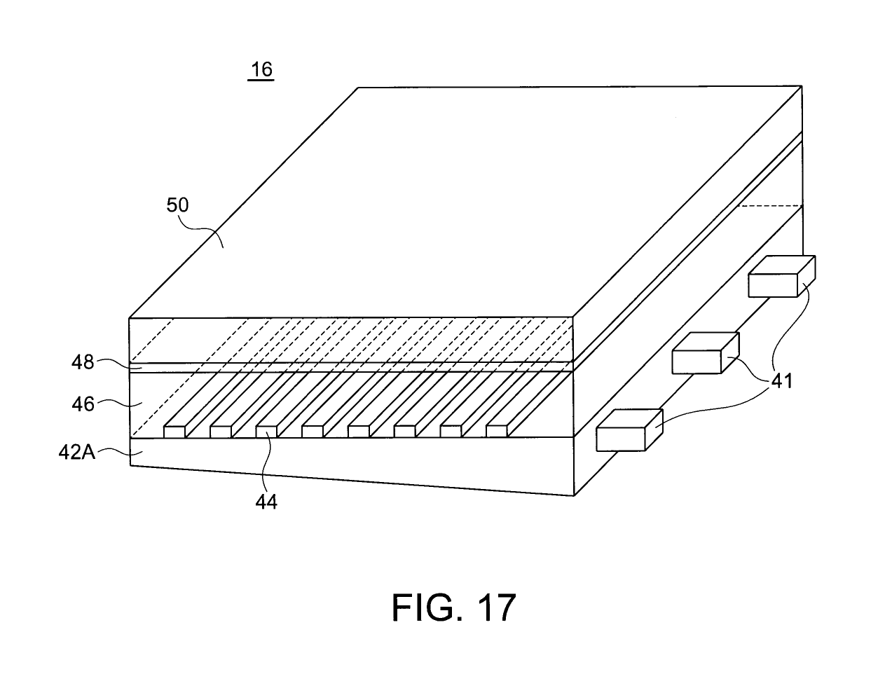

A light source unit 16 according to a first modification of the second embodiment is shown in FIG. 17. The light source unit 16 according to the first modification has a configuration obtained from the light source unit according to the second embodiment shown in FIG. 16 by replacing the one flat light source 40 with a plurality of edge light sources 41 each functioning as a flat light source and replacing the transparent substrate 42 with a transparent substrate 42A. The transparent substrate 42A has a function of the light guide plate, and a plurality of edge light sources 41 are provided on one side face of the transparent substrate 42A. And the transparent substrate 42A takes a shape of a wedge to be reduced in section area as the position moves from the side face having the edge light sources 41 to an opposite side face.

Furthermore, the first modification has a configuration in which the optical axes of light rays illuminated from the edge light are nearly perpendicular to the direction of extension of the transparent electrodes 44. Owing to such a configuration, scanning can be conducted so as to make sequential light turning on/off time of the edge light sources different according to the position in synchronism with the image rewriting period, resulting in a thinner light source unit 16. Even if the edge light sources 41 are disposed so as to make the optical axes of light rays illuminated from the edge light sources nearly parallel to the direction of extension of the transparent electrodes 44, however, the transparent electrodes 44 can function as light sources. In this way, when forming the line sources by suing the transparent electrodes 44, a pattern such as a line shape or a checkered pattern can be formed more easily as the shape of the line sources. Furthermore, it becomes possible to control the line sources themselves by dividing the transparent electrodes 44 into a plurality of sets and making voltages applied to respective sets different from each other to change the diffusion state.

### Second Modification

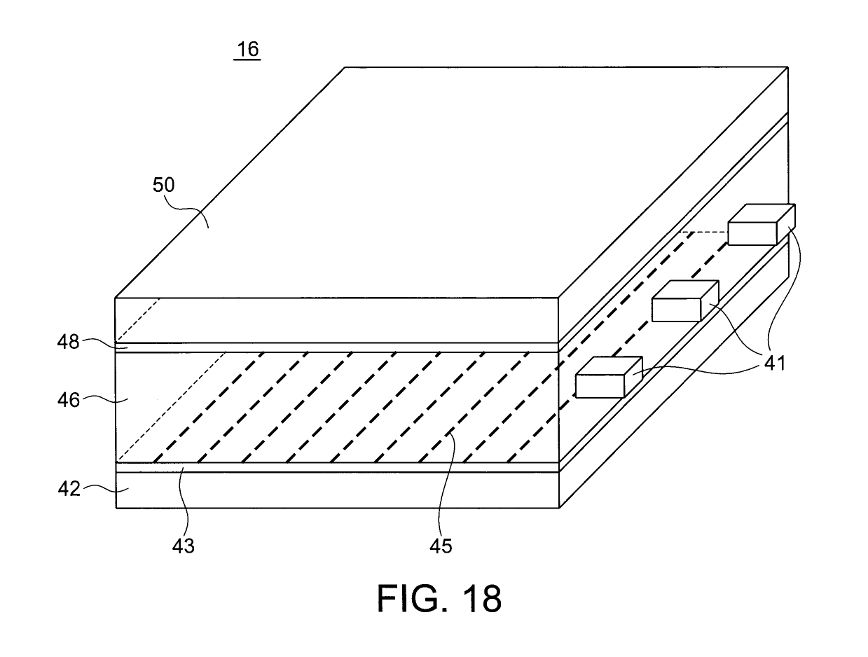

A light source unit 16 according to a second modification of the second embodiment is shown in FIG. 18. The light source unit 16 according to the second modification has a configuration obtained from the light source unit according to the second embodiment shown in FIG. 16 by replacing the one flat light source 40 with a plurality of edge light sources 41 each functioning as a flat light source and replacing the plurality of patterned transparent electrodes 44 with one transparent electrode 43 provided on the transparent substrate 42 and a scattering part 45 provided on the transparent electrode 43 and patterned so as to take a shape of line sources.

The plurality of edge light sources 41 are provided at an end part on the transparent electrode 43, and disposed so as to make optical axes of light rays illuminated from the edge light sources 41 nearly perpendicular to the direction of extension of respective parts of the line source shape of the scattering part 45. The transparent electrode 43 is formed of, for example, ITO. The diffusion state in the dispersion type liquid crystal layer 46 is removed by applying a voltage between the transparent electrode 43 and the opposed electrode 48. Light illuminated from the edge light sources 41 in this state is scattered by the scattering part 45 provided on the transparent electrode 43 and patterned so as to take a shape of line sources, and illuminated to the external via the dispersion type liquid crystal layer 46, the transparent opposed electrode, and the transparent substrate 50. Therefore, light illuminated from the light source unit 16 according to the second modification to the external takes the shape of the patterned scattering part 45, i.e., takes the shape of line sources. In this way, the scattering part 45 fulfills the function of line sources.

As the scattering part 45, for example, white ink having a high reflectance such as titanium dioxide, barium monosulfide, or a mixture of them, a dot scattering element formed by printing such as silver evaporation, or a scattering element obtained by forming a dot shaped groove with etching and conducting scattering processing.

In the second modification as well, disposition is conducted so as to make optical axes of light rays illuminated from the edge light sources 41 nearly perpendicular to the direction of extension of respective parts of the scattering part 45 which fulfill the function of line sources. In the same way as the description of the first modification shown in FIG. 17, scanning can be conducted so as to make sequential light turning on/off time of the edge light sources different according to the position in synchronism with the image rewriting period, resulting in a thinner light source unit 16.

By the way, even if the edge light sources 41 are disposed so as to make the optical axes of light rays illuminated from the edge light sources nearly parallel to the direction of extension of the scattering part 45, the scattering part 45 can fulfill the function as line sources.

### Third Modification

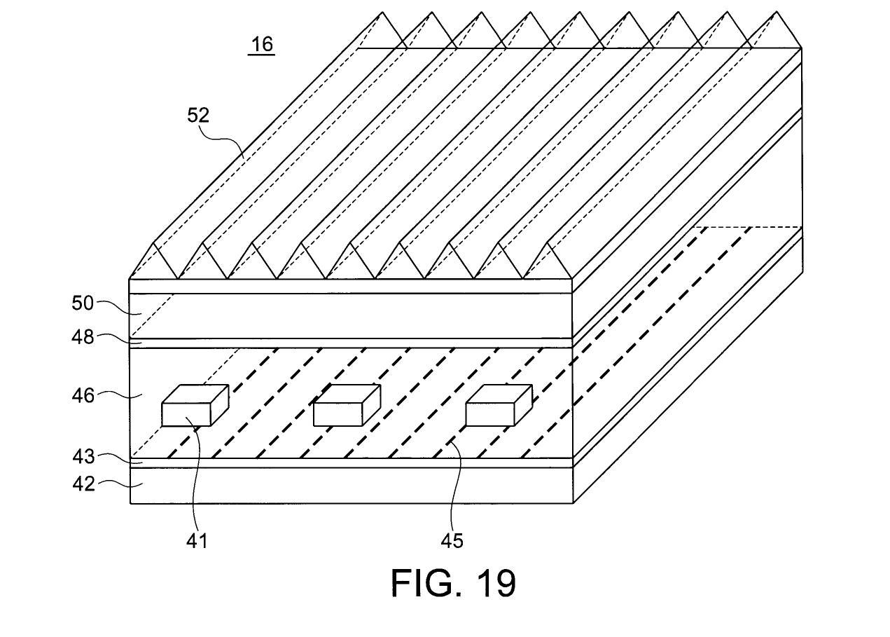

A light source unit 16 according to a third modification of the second embodiment is shown in FIG. 19. The light source unit 16 according to the third modification is obtained from the light source unit shown in FIG. 18 by disposing the plurality of edge light sources 41 each functioning as a flat light source so as to make optical axes of light rays illuminated from the edge light sources nearly parallel to the direction of extension of the scattering part 45 and providing a prism array 52 having a plurality of prisms on the transparent substrate 50. Respective prisms in the prism array 52 have ridgelines which extend in the optical axis direction of light illuminated from the edge light source 41 and are arranged in a direction of the optical axis. Owing to such a configuration, spread of the light ray distribution can be suppressed.

### Fourth Modification

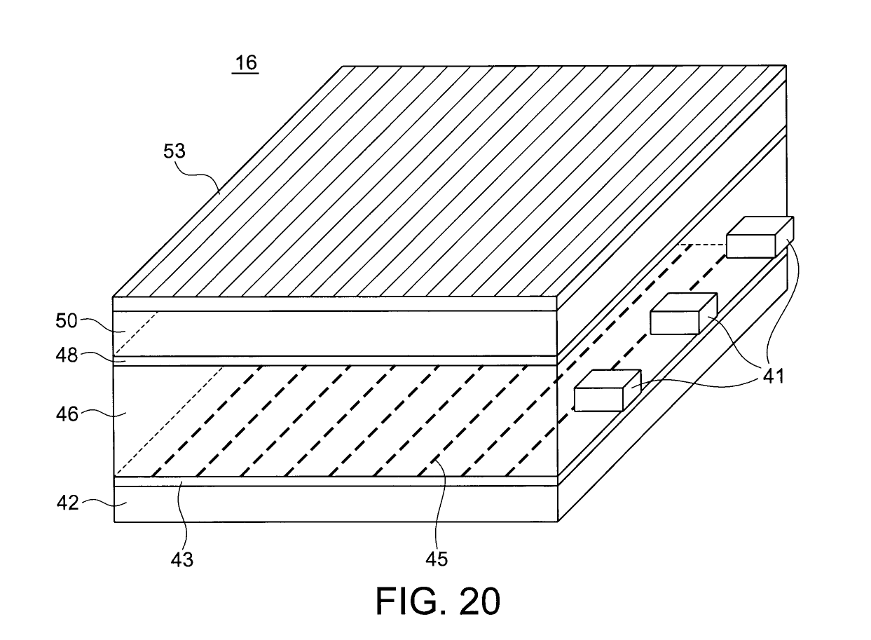

A light source unit 16 according to a fourth modification of the second embodiment is shown in FIG. 20. The light source unit according to the fourth modification has a configuration obtained from the light source unit according to the second modification shown in FIG. 18 by providing a diffusion plate 53 on the transparent substrate 50. The diffusion plate 53 has a function of diffusing light rays taken onto the transparent substrate 50 with a dot pattern in the direction of extension of respective parts of the scattering part 45 which fulfills the function of line sources. Owing to provision of the diffusion plate 53, light rays taken onto the transparent substrate 50 with the dot pattern can be converted to line-shaped light rays with a better precision.

According to the second embodiment and its modifications, it is possible to suppress the picture quality degradation and the light utilization efficiency lowering even if the switching between a two-dimensional image and a three-dimensional image is conducted.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A back light apparatus comprising:
an optical aperture part comprising a plurality of optical apertures arranged in parallel to each other;
a light source unit comprising a plurality of line sources, the light source unit configured to generate line-shaped light rays associated with the optical apertures respectively; and
a diffusion state switching unit configured to be capable of switching a diffusion state of light illuminated from the light source unit.

2. The apparatus according to claim 1, wherein the diffusion state switching unit is configured to switch the diffusion state in a region associated with each of the optical apertures.

3. The apparatus according to claim 1, wherein the light source unit comprises:
transparent first and second substrates opposed to each other;
a flat light source provided on an opposite side of the first substrate from the second substrate;
a plurality of line-shaped transparent electrodes provided on a face of a side of the first substrate on which the second substrate is located, and disposed in parallel to each other;
a transparent opposed electrode provided on a face of a side of the second substrate on which the first substrate is located, and opposed to the plurality of transparent electrodes; and
a liquid crystal layer sandwiched between the first substrate and the second substrate.

4. The apparatus according to claim 1, wherein
the light source unit comprises:
transparent first and second substrates opposed to each other;
a plurality of edge light sources provided on a first side face of the first substrate to respectively function as flat light sources;
a plurality of line-shaped transparent electrodes provided on a face of a side of the first substrate on which the second substrate is located, and disposed in parallel to each other;
a transparent opposed electrode provided on a face of a side of the second substrate on which the first substrate is located, and opposed to the plurality of transparent electrodes; and
a liquid crystal layer sandwiched between the first substrate and the second substrate, wherein
the first side face is parallel to a direction in which the plurality of electrodes extend, and
the first substrate takes a shape which reduces in section area as the position moves from the first side face to a second side face opposed to the first side face.

5. The apparatus according to claim 1, wherein the light source unit comprises:
transparent first and second substrates opposed to each other;
a transparent first electrode provided on a face of a side of the first substrate on which the second substrate is located;
a transparent second electrode provided on a face of a side of the second substrate on which the first substrate is located, and opposed to the first electrode;
a liquid crystal layer sandwiched between the first substrate and the second substrate.
a plurality of edge light sources provided at an end part on a face of the first electrode on which the second electrode is located, to each function as a flat light source; and
a plurality of scattering parts provided on a face of a side of the first electrode on which the second electrode is located, so as to be parallel to each other and in line source state to scatter light illuminated from the edge light sources.

6. The apparatus according to claim 5, further comprising a prism array having a plurality of prisms which are provided on an opposite side of the second substrate from the second electrode, which have ridgelines parallel to a direction of extension of the plurality of scattering parts, and which are disposed to be parallel to each other.

7. The apparatus according to claim 5, further comprising a diffusion plate which is provided on an opposite side of the second substrate from a side on which the second electrode is located, and which diffuses light taken out from the second substrate along a direction in which the plurality of scattering parts extend.

8. A display apparatus comprising:
a back light apparatus according to claim 1;
a display panel configured to display an image; and
a diffusion control unit configured to control switching of the diffusion state of the diffusion state switching unit in the back light apparatus in synchronism with a lighting mode of the light source unit in the back light apparatus.

9. The apparatus according to claim 8, wherein
a plurality of line sources are provided to be respectively associated with the optical apertures, and
the display apparatus further comprises:
a light source control unit configured to sequentially switch turning on and off of respective line sources; and
a synchronization control unit configured to synchronize lighting timing of line sources and switching of elemental images of the display panel with each other.

10. The apparatus according to claim 8, wherein
a direction of extension of apertures in the optical aperture part is inclined with respect to a direction of extension of the line sources, and
the diffusion state of the diffusion state switching unit is controlled by a value of a voltage applied to the diffusion state switching unit to bring about a diffusion state in a two-dimensional image display mode and bring about a diffusion state in which luminance unevenness is not substantially visually-perceived in a three-dimensional image display mode.

11. The apparatus according to claim 8, wherein
a direction of extension of apertures in the optical aperture part is parallel to a direction of extension of the line sources, and
the diffusion state of the diffusion state switching unit is controlled by a value of a voltage applied to the diffusion state switching unit to bring about a diffusion state in which luminance unevenness is not substantially visually-perceived or a haze value is maximized in a two-dimensional image display mode, and bring about a diffusion state in which luminance unevenness is not substantially visually-perceived in a three-dimensional image display mode.
